(19) United States
(12) Patent Application Publication
(10) Pub. No.: US 2026/0246379 A1
(43) Pub. Date: Aug. 20, 2026

(54) CONVERSION DEVICE, CONVERSION METHOD, AND DATA DRIVING DEVICE

(71) Applicants: LX SEMICON CO., LTD., Daejeon (KR); KOREA ADVANCED INSTITUTE OF SCIENCE AND TECHNOLOGY, Daejeon (KR)

(72) Inventors: Yoosung PARK, Daejeon (KR); Hyunsik KIM, Daejeon (KR); Yongsung AHN, Daejeon (KR); Kyungmin SHIN, Daejeon (KR)

(73) Assignees: LX SEMICON CO., LTD., Daejeon (KR); KOREA ADVANCED INSTITUTE OF SCIENCE AND TECHNOLOGY, Daejeon (KR)

(21) Appl. No.: 19/539,832

(22) Filed: Feb. 13, 2026

(30) Foreign Application Priority Data
Feb. 17, 2025 (KR) 10-2025-0020322

(51) Int. Cl. H02M 3/07

(52) U.S. Cl. CPC H02M 3/07

(57) ABSTRACT

A conversion device may include a first digital-to-analog converter that outputs two adjacent reference voltages among a plurality of reference voltages as a first voltage and a second voltage, a second digital-to-analog converter that is electrically connected to the first digital-to-analog converter and obtains a charge signal based on the first voltage and the second voltage, and a third digital-to-analog converter that is electrically connected between the first digital-to-analog converter and a data line of a display panel and supplies the first voltage as a data voltage to the data line and supplies a data voltage, which is obtained by adding an offset voltage to the first voltage, to the data line. The offset voltage may be obtained using the obtained charge signal.

### BACKGROUND

### Field of the Disclosure

The present disclosure relates to a conversion device, a conversion method, and a data driving device.

### Discussion of the Related Art

A display device converts an externally-input digital image signal into an analog signal using a digital-to-analog converter and supplies the converted signal to a display panel.

As the resolution of a display device increase, the number of bits in the digital image signal also increases.

Consequently, the capacity and number of components required to implement the digital-to-analog converter increase.

Meanwhile, the digital-to-analog converter generates a desired analog signal according to a digital image signal by using an interpolation method based on two adjacent reference voltages. However, when a difference between the two reference voltages is large, an error occurs in the generated analog signal, which causes a problem of seriously affecting linearity performance of the digital-to-analog converter. Accordingly, conventionally, linearity performance is effective in a small-signal domain in which the difference between the two reference voltages is very small.

In addition, the digital-to-analog converter and a buffer are connected in series. Consequently, a “driving-after-conversion” structure is implemented, in which the digital-to-analog converter first converts the digital image signal to an analog signal and then the output is driven through the buffer, making high-speed operation difficult.

### SUMMARY

The present disclosure aims to address the aforementioned and other problems.

Accordingly, the present disclosure provides a conversion device, a conversion method, and a data driving device that perform a novel charge-based analog conversion.

The present disclosure also provides a conversion device, a conversion method, and a data driving device with excellent linearity performance.

The present disclosure also provides a conversion device, a conversion method, and a data driving device with high-speed operation.

According to one aspect of the present disclosure to achieve the above or other objects, a conversion device, comprising: a first digital-to-analog converter configured to output two adjacent reference voltages among a plurality of reference voltages as a first voltage and a second voltage; a second digital-to-analog converter electrically connected to the first digital-to-analog converter and configured to obtain a charge signal based on the first voltage and the second voltage; and a third digital-to-analog converter electrically connected between the first digital-to-analog converter and a data line of a display panel, configured to supply the first voltage as a data voltage to the data line and supply the data voltage, which is obtained by adding an offset voltage to the first voltage, to the data line, wherein the offset voltage is obtained using the obtained charge signal.

The second digital-to-analog converter may comprise a voltage-to-charge converter configured to output a first charge signal proportional to a difference between the second voltage and the first voltage using a first capacitor electrically connected between a first node and a second node; and a charge modulator configured to modulate the output first charge signal into a second charge signal using a modulation factor.

The first charge signal may be determined by the difference between the second voltage and the first voltage.

The voltage-to-charge converter may comprise a comparator configured to compare the first voltage with the second voltage to output a second control signal; a first current source electrically connected to the first node; and a second control switch electrically connected between the first node and the first current source and configured to connect the first current source and the first capacitor in response to the second control signal to obtain the first charge signal.

The voltage-to-charge converter further may comprise a first control switch electrically connected to the first node and configured to control a supply of the second voltage for charging the first capacitor; and a first multiplexer configured to selectively output the first voltage and the second voltage.

The first control switch and the first multiplexer may be simultaneously operated in response to a first control signal.

The second charge signal may be obtained by multiplying the first charge signal by the modulation factor.

The charge modulator may comprise a plurality of second current sources electrically connected in parallel; a plurality of third control switches electrically connected to the plurality of second current sources and configured to connect the plurality of second current sources to a second capacitor of the third digital-to-analog converter in response to the second control signal; and a plurality of fourth control switches electrically connected between the second capacitor and the plurality of third control switches and configured to be selectively turned on/off in response to lower bits of a digital data signal.

The modulation factor may be obtained by selectively turning on/off the plurality of fourth control switches in response to the lower bits.

The third digital-to-analog converter may comprise a buffer; and a second capacitor feedback-connected between an output terminal and an input terminal of the buffer.

The voltage-to-charge converter may further comprise a second multiplexer electrically connected to the second node and configured to cancel an error charge signal.

The second multiplexer may supply the first voltage through the second node during a first time period, and supply the second voltage through the second node during a second time period to the first node to generate a difference value between the second voltage and the error voltage.

The third digital-to-analog converter may further comprise a fifth control switch electrically connected in parallel with the second capacitor between the output terminal and the input terminal, and configured to be selectively turned on/off depending on the first time period and the second time period.

The third digital-to-analog converter may turn on the fifth control switch during the first time period to supply the first voltage to the data line as the data voltage, turn off the fifth control switch during the second time period to inject the modulated second charge signal into the second capacitor to obtain the offset voltage, and supply to the data line the data voltage obtained by adding the obtained offset voltage to the first voltage.

According to another aspect of the present disclosure to achieve the above or other objects, a conversion method, comprising: outputting, by a first digital-to-analog converter, two adjacent reference voltages among a plurality of reference voltages as a first voltage and a second voltage; obtaining, by a second digital-to-analog converter electrically connected to the first digital-to-analog converter, a charge signal based on the first voltage and the second voltage; and supplying, by a third digital-to-analog converter electrically connected between the first digital-to-analog converter and a data line of a display panel, the first voltage to the data line as a data voltage, and supplying the data voltage, which is obtained by adding an offset voltage to the first voltage, to the data line, wherein the offset voltage is obtained using the obtained charge signal.

The obtaining of the charge signal based on the first voltage and the second voltage may comprise outputting a first charge signal proportional to a difference between the second voltage and the first voltage using a first capacitor electrically connected between a first node and a second node; and modulating the outputted first charge signal into a second charge signal using a modulation factor.

The outputting of the first charge signal may comprise comparing the first voltage with the second voltage to output a second control signal; and connecting the first current source electrically connected to the first node and the first capacitor according to the second control signal to obtain the first charge signal.

According to another aspect of the present disclosure to achieve the above or other objects, a data driving device, comprising: a plurality of conversion devices configured to supply a plurality of data voltages to a plurality of data lines of a display panel, wherein each of the plurality of conversion devices comprise: a first digital-to-analog converter configured to output two adjacent reference voltages among a plurality of reference voltages as a first voltage and a second voltage; a second digital-to-analog converter electrically connected to the first digital-to-analog converter and configured to obtain a charge signal based on the first voltage and the second voltage; and a third digital-to-analog converter electrically connected between the first digital-to-analog converter and the data line of the display panel and configured to supply the first voltage as a data voltage to the data line and supply the data voltage, which is obtained by adding an offset voltage to the first voltage, to the data line, and the offset voltage is obtained using the obtained charge signal.

The second digital-to-analog converter may comprise a voltage-to-charge converter configured to output a first charge signal proportional to a difference between the second voltage and the first voltage using a first capacitor electrically connected between a first node and a second node; and a charge modulator configured to modulate the output first charge signal into a second charge signal using a modulation factor.

The voltage-to-charge converter may comprise a comparator configured to compare the first voltage with the second voltage to output a second control signal; a first current source electrically connected to the first node; and a second control switch electrically connected between the first node and the first current source and configured to connect the first current source and the first capacitor in response to the second control signal to obtain the first charge signal.

The effects of the conversion device, conversion method, and data driving device according to the above aspects are described as follows.

According to at least one of the above aspects, there is an advantage in that high-speed driving can be achieved by having a structure that simultaneously performs a voltage-to-charge conversion operation, an operation of obtaining an offset voltage, and an output voltage supply operation, that is, a conversion-while-driving structure.

According to at least one of the above aspects, there is an advantage in that it is not necessary to increase the area or power of a comparator, the accuracy of voltage-to-voltage conversion can be improved and excellent linearity can be ensured by obtaining a first charge signal in which an error charge signal is canceled through two voltage-to-charge conversion processes.

### BRIEF DESCRIPTION OF THE DRAWINGS

The accompanying drawings are included to provide a further understanding of the present disclosure and may be incorporated into and constitute a part of the present disclosure. Furthermore, the accompanying drawings may serve to illustrate features of the present disclosure and, together with the description of the disclosure, to explain the principles of the present disclosure.

In the drawings:

FIG. 1 is a circuit diagram illustrating a conversion device according to a first aspect of the present disclosure.

FIG. 2 is a drawing explaining the overall operation of a conversion device according to the first aspect of the present disclosure.

FIG. 3 is a circuit diagram illustrating the operation of the voltage-to-charge converter of FIG. 2.

FIG. 4 is an operational waveform diagram of the voltage-to-charge converter of FIG. 2.

FIG. 5 is a circuit diagram illustrating a conversion device according to a second aspect of the present disclosure.

FIG. 6 is a circuit diagram showing the cancellation of an error charge signal generated during the operation of the voltage-to-charge converter of FIG. 5.

FIG. 7 is an operational waveform diagram showing two voltage-to-charge conversion processes in the voltage-to-charge converter of FIG. 5.

FIG. 8 is a drawing explaining the operation of the second digital-to-analog converter and the third digital-to-analog converter of FIG. 5.

FIG. 9 is an operational waveform diagram of the second digital-to-analog converter and the third digital-to-analog converter of FIG. 5.

FIG. 10 is an equivalent circuit diagram of the voltage-to-charge converter and the charge modulator of FIG. 5, respectively.

FIG. 11 is a graph showing the error rate of a charge signal according to a time period for voltage-to-charge conversion.

FIG. 12 is a graph showing the error rate of a charge signal according to the current used in a comparator.

FIG. 13A and FIG. 13B are graphs showing the differential non-linearity (DNL) and integral non-linearity (INL) of a conversion device according to the second aspect of the present disclosure.

FIG. 14 is a graph showing the output voltage of a conversion device according to the second aspect of the present disclosure.

FIG. 15 is a block diagram of a display device according to one aspect of the present disclosure.

The sizes, shapes, and dimensions of the components illustrated in the drawings may differ from the actual figures. Furthermore, even if the same components are depicted with different sizes, shapes, and dimensions across the drawings, this is merely an example within the drawings, and the same components may have the same sizes, shapes, and dimensions across the drawings.

### DETAILED DESCRIPTION

Hereinafter, the aspects disclosed in this specification will be described in detail with reference to the accompanying drawings, but the same or similar elements are given the same reference numerals regardless of reference numerals, and redundant descriptions thereof will be omitted. The suffixes ‘module’ and ‘unit’ for the elements used in the following descriptions are given or used interchangeably in consideration of ease of writing the specification, and do not themselves have a meaning or role that is distinct from each other. In addition, the accompanying drawings are for easy understanding of the aspects disclosed in this specification, and the technical idea disclosed in this specification is not limited by the accompanying drawings. Also, when an element such as a layer, region or substrate is referred to as being ‘on’ another element, this means that there may be directly on the other element or be other intermediate elements therebetween.

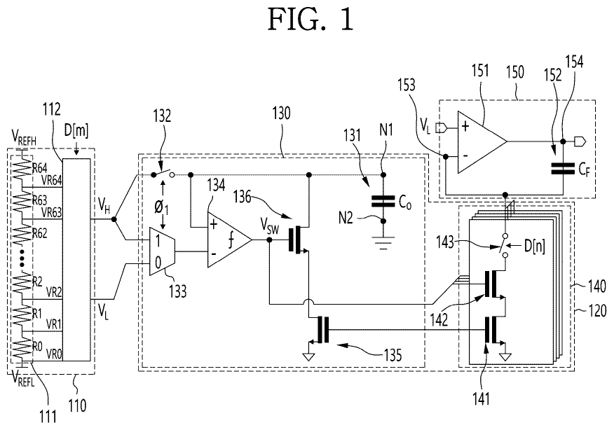

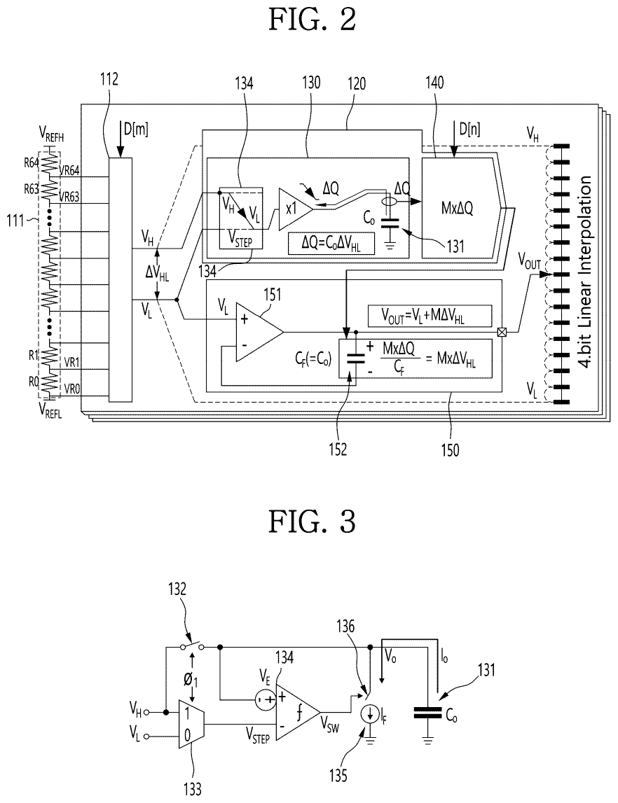

FIG. 1 is a circuit diagram illustrating a conversion device according to a first aspect of the present disclosure. FIG. 2 is a drawing explaining the overall operation of the conversion device according to the first aspect of the present disclosure.

Referring to FIGS. 1 and 2, the conversion device according to the first aspect of the present disclosure may comprise a first digital-to-analog converter 110, a second digital-to-analog converter 120, a third digital-to-analog converter 150, etc.

The conversion device according to the first aspect of the present disclosure may be a charge-based conversion device. The conversion device according to the first aspect of the present disclosure may convert voltage into charge, modulate it, convert the modulated charge back into voltage, interpolate the converted voltage, and generate a desired data voltage to supply to a data lines of the display panel.

The first digital-to-analog converter 110 may output two adjacent reference voltages among a plurality of reference voltages VR0 to VR64 as a first voltage V_{L} and a second voltage V_{H}. The second digital-to-analog converter 120 may be electrically connected to the first digital-to-analog converter 110 and may obtain a charge signal based on the first voltage V_{L} and the second voltage V_{H}.

The third digital-to-analog converter 150 may be electrically connected between the first digital-to-analog converter 110 and the data line of the display panel. In this instance, the third digital-to-analog converter 150 may supply the first voltage V_{L} as a data voltage to the data line and supply a data voltage obtained by adding an offset voltage MΔV_{HL} to the first voltage V_{L} to the data line. The offset voltage MΔV_{HL} may be obtained using the obtained charge signal. The first digital-to-analog converter 110 may comprise a resistor string 111, a switching selection circuit 112, etc.

The resistor string 111 may comprise a plurality of resistors R0 to R64 electrically connected in series between a first reference voltage VREFL and a second reference voltage VREFH. Nodes between the plurality of resistors R0 to R⁶⁴ may be electrically connected to the switching selection circuit 112, so that the plurality of reference voltages VR0 to VR64 may be output to the switching selection circuit 112.

The switching selection circuit 112 may use an upper bits D[m] of the digital data signal to select and output two adjacent reference voltages among the plurality of reference voltages VR0 to VR64 as the first voltage V_{L} and the second voltage V_{H}.

All bits D[m+n] constituting the digital data signal may be composed of the upper bits D[m] and lower bits D[n]. For example, when all bits D[m+n] constituting the digital data signal is 10 bits, for example, the 6-bit upper bits D[6] may be input to the switching selection circuit 112, and the 4-bit lower bits D[4] may be input to the fourth control switch 143 of the second digital-to-analog converter 120.

Meanwhile, the second digital-to-analog converter 120 may comprise a voltage-to-charge converter 130, a charge modulator 140, etc.

The voltage-to-charge converter 130 may output a first charge signal CS1 proportional to a value ΔVHL of the difference between the second voltage V_{H} and the first voltage V_{L}.

The voltage-to-charge converter 130 may comprise a first capacitor 131, a first control switch 132, a first multiplexer 133, a comparator 134, a first current source 135, a second control switch 136, etc.

The first capacitor 131 may be electrically connected between a first node N1 and a second node N2 and may have a first capacitance C_{O}. The second node N2 may be grounded, but is not limited thereto.

The first control switch 132 may be electrically connected to the first node N1 and may control the supply of a second voltage V_{H}. The first multiplexer 133 may receive a first voltage V_{L} and a second voltage V_{H} as inputs, and may selectively output the first voltage V_{L} and the second voltage V_{H}.

The first control switch 132 and the first multiplexer 133 may be simultaneously operated by a first control signal Φ1. The first control switch 132 and the first multiplexer 133 may be turned on/off according to the first control signal Φ1.

As an example, the first control switch 132 may be turned on in response to the first control signal Φ1 of a high level, so that the second voltage V_{H} may be supplied to the first capacitor 131 and charged therein. Accordingly, the second voltage V_{H} may be formed at the first node N1. In addition, when the first control switch 132 is turned on, the second voltage V_{H} may be supplied to a positive (+) input terminal of the comparator 134. The first multiplexer 133 may supply the second voltage V_{H} among the first voltage V_{L} and the second voltage V_{H} as a reference input voltage V_{STEP} to a negative (−) input terminal of the comparator 134 in response to the first control signal Φ1 of a high level. In this instance, since the second voltage V_{H} is supplied to both the positive (+) input terminal and the negative (−) input terminal of the comparator 134, the comparator 134 may output a second control signal V_{SW} of a low level.

As another example, the first control switch 132 is turned off in response to the first control signal Φ1 of a low level, so that the second voltage V_{H} is not supplied to the first capacitor 131. Even if the first control switch 132 is turned off, the second voltage V_{H} formed at the first node N1 may be supplied to the positive (+) input terminal of the comparator 134. The first multiplexer 133 may supply the first voltage V_{L} among the first voltage V_{L} and the second voltage V_{H} as the reference input voltage V_{STEP} to the negative (−) input terminal of the comparator 134 in response to a first control signal Φ1 of a low level. In this instance, since the second voltage V_{H} is supplied to the positive (+) input terminal of the comparator 134 and the first voltage V_{L} is supplied to the negative (−) input terminal, the comparator 134 may output a second control signal V_{SW} of a high level.

The period during which the first control switch 132 is turned on may be referred to as a charging period of the second voltage V_{H}.

The period during which the first control switch 132 is turned off may be referred to as a discharging period or charge conversion period T_{VQC} of the second voltage V_{H}.

One horizontal period T may comprise a charging period of the second voltage V_{H} and a discharging period of the second voltage V_{H}, or may comprise only a discharging period of the second voltage V_{H}. As illustrated in FIG. 4, the charging period of the second voltage V_{H} may be from t0 to t1, and the discharging period of the second voltage V_{H} may be from t1 to t2 (or t3).

The comparator 134 may compare voltages input to the positive (+) input terminal and the negative (−) input terminal, and output a second control signal V_{SW} according to the comparison result. For example, when the voltage input to the positive (+) input terminal is greater than the voltage input to the negative (−) input terminal, the comparator 134 may output a second control signal V_{SW} of a high level. For example, when the voltage input to the positive (+) input terminal is equal to the voltage input to the negative (−) input terminal, the comparator 134 may output a second control signal V_{SW} of a low level.

The first current source 135 may be electrically connected to the first node N1 and may be a source that supplies a current IF. The current IF may be a constant current, but is not limited thereto. When the current IF flows to the first capacitor 131, the charge of the second voltage V_{H} formed at the first node N1 is lost, so that the second voltage V_{H} at the first node N1 may decrease with a slope of IF/CO. Accordingly, the second voltage V_{H} supplied to the positive (+) input terminal of the comparator 134 may also decrease with a slope of IF/CO.

The first current source 135 may form a current mirror circuit with each of a plurality of second current sources 141 of the charge modulator 140. That is, the current IF flowing in the first current source 135 may be copied to the second current source 141, so that the current IF flowing in the first current source 135 may flow to the second current source 141.

The second control switch 136 may be electrically connected between the first node N1 and the first current source 135. The second control switch 136 may electrically connect or disconnect the first current source 135 and the first capacitor 131 according to the second control signal V_{SW}.

The second control switch 136 may be turned on in response to a second control signal V_{SW} of a high level. In this instance, since the first node N1 and the first current source 135 are electrically connected, the current IF of the first current source 135 flows through the first capacitor 131, and thus an output current I_{O} may be equal to the current IF flowing through the first current source 135. That is, a first current path through which current IF flows may be formed through the first capacitor 131, the first node N1, the second control switch 136, and the first current source 135. Since the charge stored in the first capacitor 131 is lost due to the output current I_{O} flowing through the first capacitor 131, an output voltage V_{O} may be reduced with a slope of IF/CO. In this instance, the second voltage V_{H} supplied to the positive (+) input terminal of the comparator 134 may also be reduced with a slope of IF/CO.

When the second voltage V_{H} of the first node N1 is reduced and becomes equal to the first voltage V_{L}, the second voltage V_{H}, which is reduced to be equal to the first voltage V_{L}, is supplied to the positive (+) input terminal of the comparator 134, and the comparator 134 may output a second control signal V_{SW} of a low level. Accordingly, the second control switch 136 may be turned off in response to the second control signal V_{SW} of the low level, thereby disconnecting the first node N1 and the first current source 135. In this instance, since the current IF does not flow to the first capacitor 131, the output current I_{O} may be 0. Even though the first capacitor 131 is charged with charges, since the current IF does not flow to the first capacitor 131, the output voltage V_{O} may also be 0.

Accordingly, the current IF may flow to the first capacitor 131 by the second control signal V_{SW} of the high level output from the comparator 134 until the second voltage V_{H} supplied to the positive (+) input terminal of the comparator 134 decreases with the slope of IF/CO and becomes equal to the first voltage V_{L}, thereby obtaining the first charge signal CS1. The first charge signal CS1 may be a charge change amount ΔQ. The first charge signal CS1 may be expressed by the following equation 1, as illustrated in FIG. 4.

$$CS 1 = Δ Q = CO Δ VHL = IFTVQC \qquad [ Equation 1 ]$$

CO is a first capacitance of the first capacitor 131, ΔVHL is the difference between the second voltage V_{H} and the first voltage V_{L}, and TVQC may be a charge conversion period.

As shown in equation 1, the first charge signal CS1 may be determined by the difference ΔVHL between the second voltage V_{H} and the first voltage V_{L}. The charge conversion period T_{VQC} may be a period during which the second voltage V_{H} supplied to the positive (+) input terminal of the comparator 134 decreases at a slope of IF/CO until it becomes equal to the first voltage V_{L}.

Meanwhile, the charge modulator 140 may modulate the first charge signal CS1 into the second charge signal CS2 using a modulation factor M.

The charge modulator 140 may comprise a plurality of second current sources 141, a plurality of third control switches 142, a plurality of fourth control switches 143, etc.

The plurality of second current sources 141 may be electrically connected in parallel with each other. The plurality of second current sources 141 may be electrically commonly connected to an input terminal 153 of a buffer 151 of a third digital-to-analog converter 150. The plurality of second current sources 141 may be commonly connected to one side of a second capacitor 152 of the third digital-to-analog converter 150.

Each of the plurality of second current sources 141 may generate a plurality of currents IF. The plurality of currents IF may each be a current IF flowing through a first current source 135. To this end, the first current source 135 and each of the plurality of second current sources 141 may form a current mirror circuit. Accordingly, the current IF flowing through the first current source 135 may be copied to each of the plurality of second current sources 141, so that a plurality of currents IF may be generated from the plurality of second current sources 141.

In the present disclosure, the current IF generated from each of the plurality of second current sources 141 is described as being the same as the current IF flowing through the first current source 135, but may be greater than the current IF flowing through the first current source 135.

In the present disclosure, the currents IF generated from of the plurality of second current sources 141 are described as being the same, but may be different from each other.

The plurality of third control switches 142 may be electrically connected to a plurality of second current sources 141, respectively. The plurality of third control switches 142 may connect each of the plurality of second current sources 141 to a second capacitor 152 of the third digital-to-analog converter 150 according to a second control signal V_{SW}. In this instance, the current IF generated in the second current source 141 may flow to the second capacitor 152. Accordingly, a second current path may be formed through which the current IF flows through the second capacitor 152, at least one of the plurality of third control switches 142, and at least one of the plurality of second current sources 141.

The plurality of fourth control switches 143 may be electrically connected between the second capacitor 152 and the plurality of third control switches 142. The plurality of fourth control switches 143 may be electrically connected in series to each of the plurality of third control switches 142.

The plurality of fourth control switches 143 may be selectively turned on/off according to the lower bits D[n] of the digital data signal.

When the lower bits D[n] of the digital data signal is 4 bits, the charge modulator 140 may comprise the second-first to second-fourth current sources, the third-first to third-fourth control switches, and the fourth-first to fourth-fourth control switches.

The third-first to third-fourth control switches may be turned on in response to a second control signal V_{SW} of a high level. For example, when the lower bits D[n] of the digital data signal is 1001, D[3] may be 1, D[2] may be 0, D[1] may be 0, and D[0] may be 1. In this instance, D[3] may be supplied to the fourth-fourth control switch, D[2] may be supplied to the fourth-third control switch, D[1] may be supplied to the fourth-second control switch, and D[0] may be supplied to the fourth-first control switch. Accordingly, the fourth-fourth control switch and the fourth-first control switch may be turned on, respectively, and the fourth-third control switch and the fourth-second control switch may be turned off.

Since the second-fourth current source and the second capacitor 152 are electrically connected by the turned-on fourth-fourth control switch, a second-fourth current path may be formed through which the current IF flows through the second capacitor 152, the fourth-fourth control switch, and the second-fourth current source. Furthermore, since the second-first current source and the second capacitor 152 are electrically connected by the turned-on fourth-first control switch, a second-first current path may be formed through which a current IF flows through the second capacitor 152, the fourth-first control switch, and the second-first current source. In this instance, an output current I_{M} may be determined using the current IF on the second-fourth current path and the current IF on the second-first current path.

Therefore, the modulation factor M may be obtained by selectively turning on/off a plurality of fourth control switches 143 according to the lower bits D[n] of the digital data signal.

The second charge signal CS2 may be obtained using the modulation factor M obtained by the charge modulator 140. The second charge signal CS2 may be expressed by the following equation 2.

$$CS 2 = M Δ Q = M Δ VHLCO \qquad [ Equation 2 ]$$

M is a modulation factor, ΔQ is a charge change amount, ΔVHL is a value of the difference between the second voltage V_{H} and the first voltage V_{L}, and CO may be a first capacitance of the first capacitor 131.

As described above, since the charge change amount ΔQ is the first charge signal CS1, the second charge signal CS2 may be obtained by multiplying the first charge signal CS1 by the modulation factor M.

Meanwhile, the third digital-to-analog converter 150 may comprise a buffer 151, a second capacitor 152, etc.

The third digital-to-analog converter 150 may obtain an offset voltage MΔV_{HL} between the first voltage V_{L} and the second voltage V_{H}, and supply a data voltage obtained by adding the offset voltage MΔV_{HL} to the first voltage V_{L} to the data line of the display panel. The offset voltage MΔV_{HL} may be obtained using the second capacitor 152.

The buffer 151 may be electrically connected to the first digital-to-analog converter 110 and supply the first voltage V_{L} to the data line of the display panel.

The second capacitor 152 may be feedback-connected between an input terminal 153 and an output terminal 154 of the buffer 151. The second capacitor 152 may have a second capacitance CF. For example, the second capacitance CF may have the same value as the first capacitance C_{O} of the first capacitor 131, but is not limited thereto.

One side of the second capacitor 152 may be electrically connected to the input terminal 153 of the buffer 151. The other side of the second capacitor 152 may be electrically connected to one side of the charge modulator 140. The other side of the second capacitor 152 may be commonly connected to a plurality of second current sources 141. As described above, the plurality of second current sources 141 may be individually connected or disconnected to the other side of the second capacitor 152 depending on the turning on/off of each of the plurality of fourth control switches 143.

The offset voltage MΔV_{HL} may be obtained by injecting the second charge signal CS2 obtained by the charge modulator 140 into the second capacitor 152. In this instance, an output voltage Vₒᵤₜ may be obtained by adding the offset voltage MΔV_{HL} to the first voltage V_{L}. Here, the output voltage Vₒᵤₜ may be an analog voltage.

When the second charge signal CS2 is injected into the second capacitor 152, the output voltage Vₒᵤₜ (or data voltage) may be expressed by equation 3.

$$Vout = {V}_{L} + ( M Δ VHLCO ) / CF = {V}_{L} + M Δ VHL = {V}_{L} + M ( V H - {V}_{L} ) \qquad [ Equation 3 ]$$

According to the present disclosure, by the third digital-to-analog converter 150 being electrically connected to the first digital-to-analog converter 110 that outputs a first voltage V_{L} and a second voltage V_{H}, the first voltage V_{L} may be supplied to a data line of a display panel through the third digital-to-analog converter 150 while charge modulation is performed in the second digital-to-analog converter 120. Accordingly, the data line of the display panel may be pre-charged with the first voltage V_{L}. Thereafter, an offset voltage MΔV_{HL} obtained based on a result of the charge modulation may be supplied to the data line, whereby the data line of the display panel can be rapidly charged from the pre-charged first voltage V_{L} to the offset voltage MΔV_{HL}, and thus high-speed driving can be possible through the conversion device of the present disclosure. As such, a conversion device according to one aspect of the present disclosure may have a conversion-while-driving structure.

FIG. 3 is a circuit diagram illustrating the operation of the voltage-to-charge converter of FIG. 2. FIG. 4 is an operating waveform diagram of the voltage-to-charge converter of FIG. 2.

As illustrated in FIGS. 3 and 4, when the first control switch 132 is turned on in response to the first control signal Φ1 of a high level at t0, the second voltage V_{H} may be charged to the first capacitor 131 via the first control switch 132. In addition, the second voltage V_{H} may be supplied to a positive (+) input terminal of the comparator 134 via the first control switch 132. The first multiplexer 133 may supply the second voltage V_{H} as the reference input voltage V_{STEP} to the negative (−) input terminal of the comparator 134 according to the first control signal Φ1 of the high level.

The comparator 134 may output the second control signal V_{SW} of a high level when the voltage of the positive (+) input terminal is greater than the voltage of the negative (−) input terminal, and may output the second control signal V_{SW} of a low level when the voltage of the positive (+) input terminal is equal to the voltage of the negative (−) input terminal.

As described above, since the positive (+) input terminal and the negative (−) input terminal of the comparator 134 receive the same voltage, i.e., the second voltage V_{H}, the comparator 134 may output the second control signal V_{SW} of a low level. The second control switch 136 is turned off in response to the second control signal V_{SW} of the low level, so that the output current I_{O} flowing through the first capacitor 131 may become 0.

Thereafter, at time t1, the first control signal Φ1 may change from a high level to a low level.

The first control switch 132 may be turned off in response to a first control signal Φ1 of a low level. Even if the first control switch 132 is turned off, since a voltage of the first node N1 is maintained at the second voltage V_{H}, the second voltage V_{H} may be supplied to the positive (+) input terminal of the comparator 134. The first multiplexer 133 may supply a first voltage V_{L} to the negative (−) input terminal of the comparator 134 in response to a first control signal Φ1 of a low level.

Since the voltage of the positive (+) input terminal of the comparator 134 is the second voltage V_{H} and the voltage of the negative (−) input terminal is the first voltage V_{L}, the comparator 134 may output a second control signal V_{SW} of a high level. The second control switch 136 is turned on in response to the second control signal V_{SW} of a high level, so that a first current path may be formed through the first capacitor 131, the second control switch 136, and the first current source 135. Accordingly, the output current I_{O} may be the current IF of the first current source 135. As the output current I_{O} flows to the first capacitor 131, the charge of the first capacitor 131 may be lost, and the second voltage V_{H} charged in the first capacitor 131 may decrease with a slope of IF/CO. Accordingly, the second voltage V_{H} input to the positive (+) input terminal of the comparator 134 may also decrease with a slope of IF/CO.

When the second voltage V_{H} input to the positive (+) input terminal of the comparator 134 is decreased to be the same as a reference input voltage V_{STEP} of the negative (−) input terminal of the comparator 134, that is, the first voltage V_{L}, the comparator 134 may output a second control signal V_{SW} of a low level. That is, at t2, the second voltage V_{H} input to the positive (+) input terminal of the comparator 134 becomes the same as the first voltage V_{L} of the negative (−) input terminal of the comparator 134, and thus a low level of a second control signal V_{SW} may be output from the comparator 134, and the second control switch 136 may be turned off in response to the second control signal V_{SW} of a low level, so that an output current I_{O} may become 0.

As illustrated in FIG. 4, the second control switch 136 may be turned on in response to the second control signal V_{SW} of the high level output from the comparator 134 during t1 to t2, so that the current IF of the first current source 135 may flow to the first capacitor 131 as the output current I_{O}. In this instance, the period between t1 and t2 may be defined as a charge conversion period T_{VQC}.

Therefore, the voltage-to-charge converter 130 may obtain a first charge signal CS1 representing the charge change amount ΔQ, as shown in Equation 1.

The charge change amount ΔQ may be a product of the first capacitance C_{O} of the first capacitor 131 and the difference value ΔVHL between the second voltage V_{H} and the first voltage V_{L}, or a product of the current IF of the first current source 135 and the charge conversion period T_{VQC}.

Meanwhile, unless the comparator 134 is ideal, an error voltage V_{E} may be generated, as shown in Equation 4.

$${V}_{E} = {V}_{OS} + \frac{{V}_{D D}}{{A}_{CMP}} + \frac{{I}_{F}}{{C}_{O}} {t}_{dcmp} \qquad [ Equation 4 ]$$

V_{OS} may be an internal voltage of the comparator 134, A_{CMP} may be a sensitivity, VDD may be a high level of the second control signal V_{SW}, and t_{dcmp} may be a delay time.

When the comparator 134 is ideal, the internal voltage V_{OS} and the delay time t_{dcmp} of the comparator 134 are each 0, and the sensitivity A_{CMP} has an infinite value, so that the error voltage V_{E} may be 0. In this instance, at t2, the second voltage V_{H} of the positive (+) input terminal of the comparator 134 may be equal to the first voltage V_{L} of the negative (−) input terminal, so that the second control switch 136 may be turned off by a second control signal V_{SW} of a low level output from the comparator 134, and the output current I_{O} may be 0.

However, when the comparator 134 is not ideal, the error voltage V_{E} may be generated. In this instance, since the second voltage V_{H} of the positive (+) input terminal of the comparator 134 at t2 is greater than the first voltage V_{L} of the negative (−) input terminal due to the error voltage V_{E}, a second control signal V_{SW} of a high level, rather than a second control signal V_{SW} of a low level, may be output from the comparator 134. Accordingly, the second control switch 136 is still maintained in a turned-on state, so that the current IF of the first current source 135 flows to the first capacitor 131 as the output current I_{O}, and the second voltage V_{H} of the first node N1 may become smaller than the first voltage V_{L}.

A period in which the error charge signal QE due to the error voltage V_{E} is generated may be defined as an error occurrence period T_{ERR}.

Thereafter, at t3, when the second voltage V_{H} of the first node N1 is reduced by the value obtained by subtracting the error voltage V_{E} from the first voltage V_{L} and the reduced value is supplied to the positive (+) input terminal of the comparator 134, the voltage of the positive (+) input terminal of the comparator 134 and the negative (−) voltage may become the same. Accordingly, the second control switch 136 may be turned off by a second control signal V_{SW} of a high level output from the comparator 134, so that the output current I_{O} may become 0. Accordingly, an error charge signal QE may be generated during t2 to t3. The error charge signal QE may be QE=COVE.

In order to reduce the error voltage V_{E}, as shown in Equation 4, an internal voltage V_{OS} of the comparator 134 may be reduced by increasing an area of the comparator 134, or a sensitivity A_{CMP} may be increased or a delay time t_{dcmp} may be reduced by increasing power consumed in the comparator 134. However, in this case, there is a problem in that the area of the comparator 134 is increased or the power is increased. That is, there is a trade-off relationship between accuracy and area and/or power.

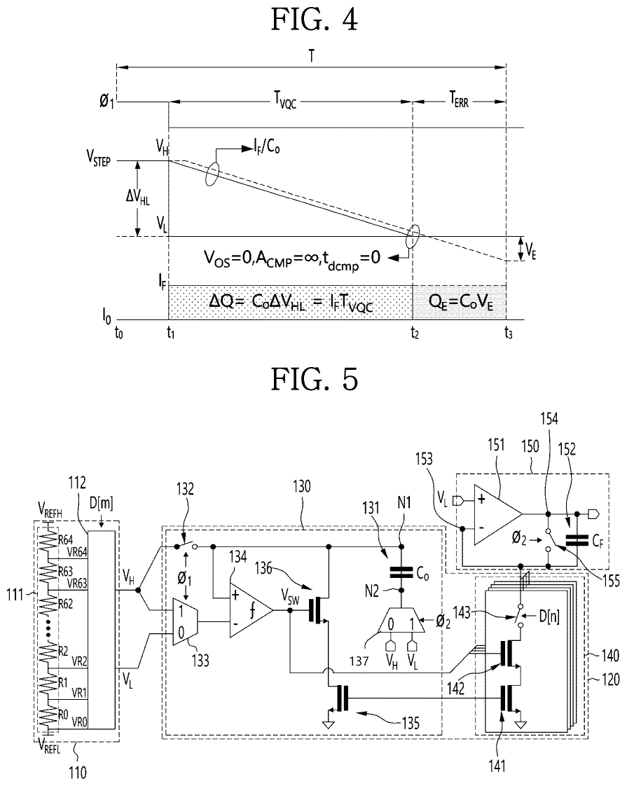

The present disclosure proposes a conversion device capable of eliminating the error voltage V_{E} without increasing the area or power of the comparator 134. This is described in more detail with reference to the second aspect of the present disclosure (FIGS. 5 to 10) described below.

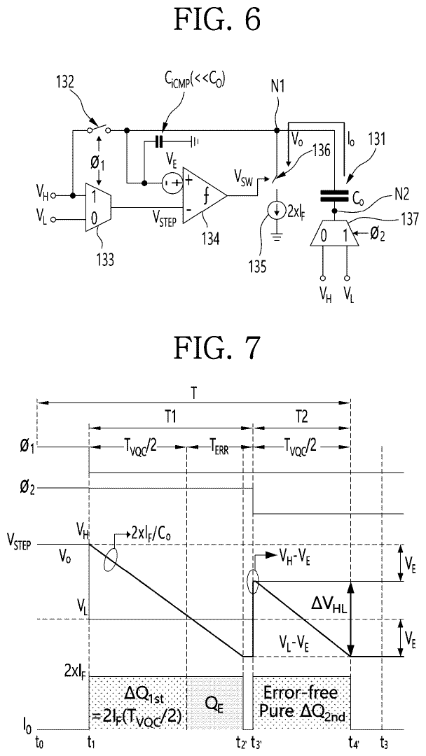

FIG. 5 is a circuit diagram illustrating a conversion device according to the second aspect of the present disclosure. FIG. 6 is a circuit diagram showing that an error charge signal generated during the operation of the voltage-to-charge converter of FIG. 5 is canceled. FIG. 7 is an operational waveform diagram showing two voltage-to-charge conversion processes in the voltage-to-charge converter of FIG. 5.

The second aspect of the present disclosure is identical to the first aspect of the present disclosure (FIGS. 1 to 4) except for the second multiplexer 137 and the fifth control switch 155. Components having the same structure and/or function as those of the first aspect of the present disclosure (FIGS. 1 to 4) in the second aspect of the present disclosure are assigned the same reference numerals, and detailed descriptions are omitted.

Referring to FIG. 5, the conversion device according to the second aspect of the present disclosure may comprise a first digital-to-analog converter 110, a second digital-to-analog converter 120, a third digital-to-analog converter 150, etc.

The second digital-to-analog converter 120 may comprise a voltage-to-charge converter 130, a charge modulator 140, a second multiplexer 137, etc.

The second multiplexer 137 may be provided to cancel an error charge signal QE. The second multiplexer 137 may be electrically connected to a second node N2 of the first capacitor 131. A first voltage V_{L} and a second voltage V_{H} may be input to the second multiplexer 137. The second multiplexer 137 may selectively output the first voltage V_{L} and the second voltage V_{H} according to a third control signal Φ2. The second multiplexer 137 may select the first voltage V_{L} according to a high level of the third control signal Φ2 and supply the first voltage V_{L} to the second node N2. The second multiplexer 137 may select the second voltage V_{H} according to a low level of the third control signal Φ2 and supply the second voltage V_{H} to the second node N2.

As illustrated in FIG. 7, one horizontal period T may be divided into a charging period of the second voltage V_{H} and a discharging period of the second voltage V_{H}. That is, the charging period of the second voltage V_{H} may be from t0 to t1, and the discharging period of the second voltage V_{H} may be from t1 to t4′. The discharge period of the second voltage V_{H} may comprise a first time period T1 and a second time period T2. In this instance, the second voltage V_{H} on the first node N1 may be discharged during each of the first time period T1 and the second time period T2.

As described above, voltage-to-charge conversion may be performed through discharging of the second voltage V_{H}. Accordingly, the error charge signal QE may be canceled through two voltage-to-charge conversion processes. That is, the error charge signal QE may be generated through a voltage-to-charge conversion process during a first time period T1. Thereafter, during a second time period T2, the error charge signal QE is canceled and removed through a voltage-to-charge conversion process, thereby generating a second charge signal CS2, so that accuracy of voltage-to-voltage conversion can be improved and excellent linearity can be secured.

As illustrated in FIGS. 6 and 7, during t0 and t1, a first control signal Φ1 of a high level may be provided to the first control switch 132 and the first multiplexer 133, and a third control signal Φ2 of a high level may be provided to the second multiplexer 137. In this instance, the first voltage V_{L} selected by the third control signal Φ2 of a high level in the second multiplexer 137 may be provided to the second node N2. The first control switch 132 may be turned on by the first control signal Φ1 of a high level, so that the second voltage V_{H} output from the first digital-to-analog converter 110 may be provided to the first node N1. Accordingly, the value ΔVHL of the difference between the second voltage V_{H} and the first voltage V_{L} may be charged in the first capacitor 131, and the voltage of the first node N1 may be maintained at the second voltage V_{H}. The second voltage V_{H} may be supplied to a positive (+) input terminal of the comparator 134. The second voltage V_{H} selected by the first control signal Φ1 of a high level in the first multiplexer 133 may be supplied as the reference input voltage V_{STEP} to a negative (−) input terminal of the comparator 134. In this instance, since the second control switch 136 may be turned off by the second control signal V_{SW} of a low level output from the comparator 134, the output current I_{O} may be 0.

At t1, the first control signal Φ1 of a low level may be supplied to the first control switch 132 and the first multiplexer 133, and the third control signal Φ2 of a high level may be supplied to the second multiplexer 137. In this instance, the first control switch 132 may be turned off, and the first voltage V_{L} selected by the first multiplexer 133 may be supplied to the negative (−) input terminal of the comparator 134. In addition, even if the first control switch 132 is turned off, the second voltage V_{H} of the first node N1 may be supplied to the positive (+) input terminal of the comparator 134. Accordingly, the second control switch 136 may be turned on by the second control signal V_{SW} of the high level output from the comparator 134, so that the output current I_{O}, which is the current IF of the first current source 135, may flow to the first capacitor 131.

During t1 to t2′, the second voltage V_{H} of the first node N1 may decrease with a slope of 2IF/CO. When the second voltage V_{H} of the first node N1 decreases by the amount obtained by subtracting the error voltage V_{E} from the first voltage V_{L} due to the error voltage V_{E} of the comparator 134, a second control signal V_{SW} of a low level may be output from the comparator 134, so that the output current I_{O} may become 0 by turning off the second control switch 136. Accordingly, the voltage-to-charge converter 130 may obtain the first charge signal CS1 and the error charge signal QE during the first time period T1.

Thereafter, at t3′, a third control signal Φ2 of a low level is provided to the second multiplexer 137, such that the second voltage V_{H} selected by the second multiplexer 137 may be supplied to the second node N2. Accordingly, as the second node N2 is raised from the first voltage V_{L} to the second voltage V_{H}, the first node N1 becomes a value obtained by subtracting an error voltage V_{E} from the second voltage V_{H} due to AC coupling, and an output voltage V_{O} represented by Equation 5 may be obtained.

$${V}_{O} = {V}_{L} - {V}_{E} + \frac{{C}_{O}}{{C}_{O} + {C}_{iCMP}} Δ {V}_{HL} \approx {V}_{H} - {V}_{E} \qquad [ Equation 5 ]$$

C_{iCMP} may be a capacitance on an input side of the comparator 134. The capacitance C_{iCMP} on the input side of the comparator 134 may be negligibly small compared to the first capacitance C_{O} of the first capacitor 131.

In this case, a voltage of the first node N1 supplied to the positive (+) input terminal of the comparator 134 may be an output voltage V_{O} represented by Equation 5, and may be greater than the first voltage V_{L}. Accordingly, the comparator 134 may output a second control signal V_{SW} of a high level, such that the second control switch 136 may be turned on, whereby an output current I_{O}, which is a current IF of the first current source 135, may flow to the first capacitor 131. Accordingly, the voltage of the first node N1 may be decreased with a slope of 2IF/CO.

Since the voltage supplied to the positive (+) input terminal of the comparator 134 at T4′ becomes equal to the first voltage V_{L}, the comparator 134 may output a second control signal V_{SW} of a low level, such that the second control switch 136 may be turned off, whereby an output current I_{O} may become 0.

As illustrated in FIG. 7, during t3′ to t4′, i.e., during the second time period T2, the output voltage V_{O} decreases from (VH−VE) to (V_{L}−VE), so that the output voltage V_{O} may change by exactly ΔVHL. In this instance, the charge change amount ΔQ may be COΔVHL[=CO(VH V_{L})], and the first charge signal CS1 may be obtained using the charge change amount ΔQ.

Accordingly, the error charge signal QE may be generated during the first time period T1, and a first charge signal CS1 in which the error charge signal QE is removed may be obtained during the second time period T2.

As illustrated in FIG. 11, when a current of the first current source 135 is increased to 2IF in order to shorten a charge conversion period T_{VQC}, an error such as an error voltage V_{E} may also be increased (comparative example). However, as in the embodiment, the charge conversion period T_{VQC} may be shortened and the error may be canceled through two voltage-to-charge conversion processes. That is, even when the charge conversion period T_{VQC} is shortened, an error-free first charge signal CS1 and a charge variation amount ΔQ may be obtained. The charge conversion period T_{VQC} may be dramatically reduced by up to 95% without error.

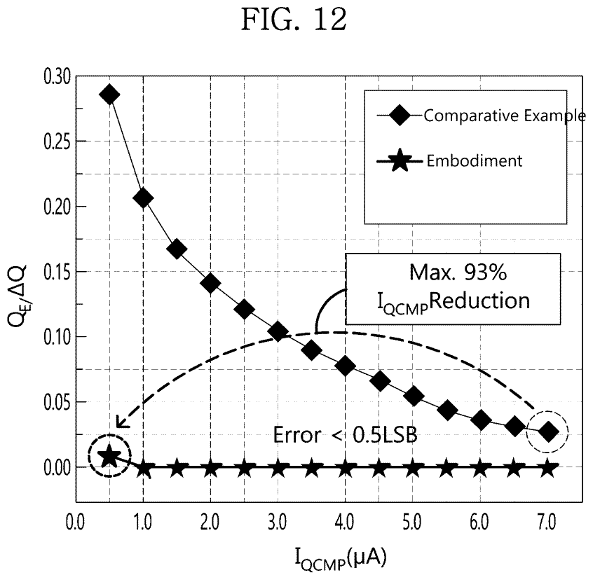

As illustrated in FIG. 12, when a current IQCM used in the comparator 134 is reduced, a sensitivity A_{CMP} is reduced and a delay time t_{dcmp} is increased, such that an error such as an error voltage V_{E} may be increased (comparative example). However, as in the embodiment, the current IQCM may be reduced and the error may be canceled through two voltage-to-charge conversion processes. That is, even when the current IQCM is reduced, an error-free first charge signal CS1 and a charge variation amount ΔQ may be obtained. The current IQCM may be dramatically reduced by up to 93% without error.

As illustrated in FIGS. 11 and 12, it can be seen that an error is less than 0.5 LSB (Least Significant Bit).

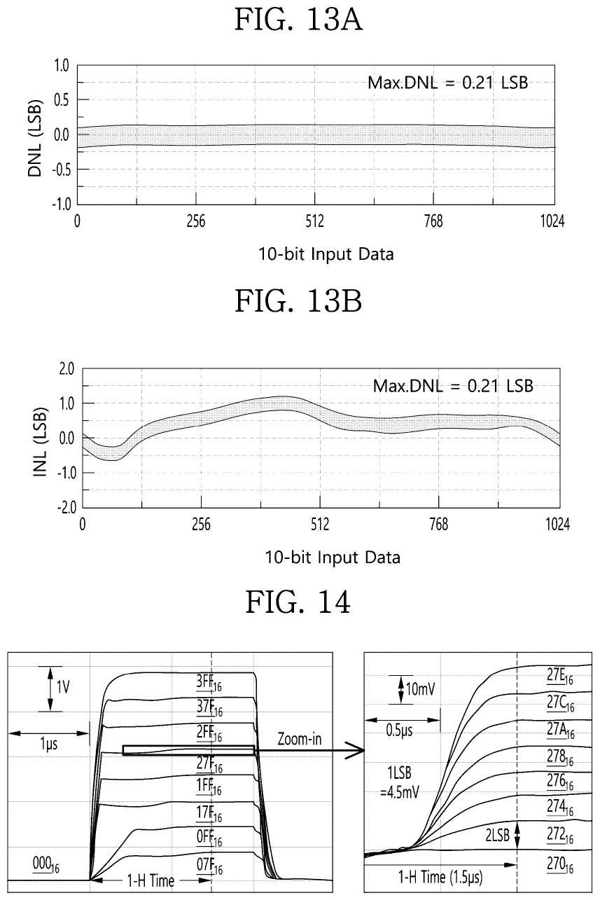

Meanwhile, a maximum DNL measured in the conversion device of the present disclosure is 0.21 LSB (FIG. 13A), and a maximum INL may be 1.21 LSB (FIG. 13B). DNL and INL may be indicators representing characteristics of a digital-to-analog converter (DAC). From FIGS. 13A and 13B, the conversion device of the present disclosure can secure excellent linearity.

According to the present disclosure, by obtaining a first charge signal CS1 in which an error charge signal QE is canceled through two voltage-to-charge conversion processes, it is not necessary to increase an area of the comparator 134 or to increase power, and accuracy of voltage-to-voltage conversion can be improved and excellent linearity can be secured.

Meanwhile, referring back to FIG. 5, the third digital-to-analog converter 150 may comprise a buffer 151, a second capacitor 152, a fifth control switch 155, etc.

The third digital-to-analog converter 150 may be electrically connected to the first digital-to-analog converter 110.

The fifth control switch 155 may be electrically connected between an output terminal 154 and an input terminal 153 of the buffer 151. The fifth control switch 155 may be electrically connected in parallel with the second capacitor 152.

The buffer 151 may have a positive (+) terminal to receive the first voltage V_{L} and the positive (+) terminal may be electrically connected to an output terminal at which the first voltage V_{L} is output from the first digital-to-analog converter 110.

The fifth control switch 155 may be selectively turned on/off according to the first time period T1 and the second time period T2. The fifth control switch 155 and the second multiplexer 137 may be operated simultaneously by the third control signal Φ2.

As an example, the fifth control switch 155 may be turned on by the third control signal Φ2 of a high level during the first time period T1. In this instance, the buffer 151 may be configured with a unity gain configuration, so that the output voltage Vₒᵤₜ tracking the first voltage V_{L} input to the buffer 151 may be supplied as a data voltage to the data line of the display panel. Since the output current I_{M} of the buffer 151 flows to the input terminal 153 of the buffer 151 via the fifth control switch 155 instead of the second capacitor 152, the output voltage Vₒᵤₜ of the buffer 151 may quickly track the first voltage V_{L}.

As another example, the fifth control switch 155 may be turned off by a third control signal Φ2 of a low level during the second time period T2. In this instance, the second charge signal CS2 obtained from the second digital-to-analog converter 120 may be injected, thereby obtaining the offset voltage MΔV_{HL}. The third digital-to-analog converter 150 may supply the output voltage Vₒᵤₜ obtained by adding the offset voltage MΔV_{HL} to the first voltage V_{L} as a data voltage to the data line.

According to the present disclosure, during the first time period T1, an output voltage Vₒᵤₜ that follows the first voltage V_{L} may be supplied to a data line together with a voltage-to-charge conversion operation, and during the second time period T2, an offset voltage MΔV_{HL} may be additionally supplied. That is, a conversion device according to the present disclosure has a structure that simultaneously performs a voltage-to-charge conversion operation, an operation of obtaining the offset voltage MΔV_{HL}, and supply of the output voltage Vₒᵤₜ, that is, a conversion-while-driving structure, whereby high-speed driving may be possible.

As illustrated in FIG. 14, since one horizontal period T is less than 1.5 μs, high-speed operation is possible.

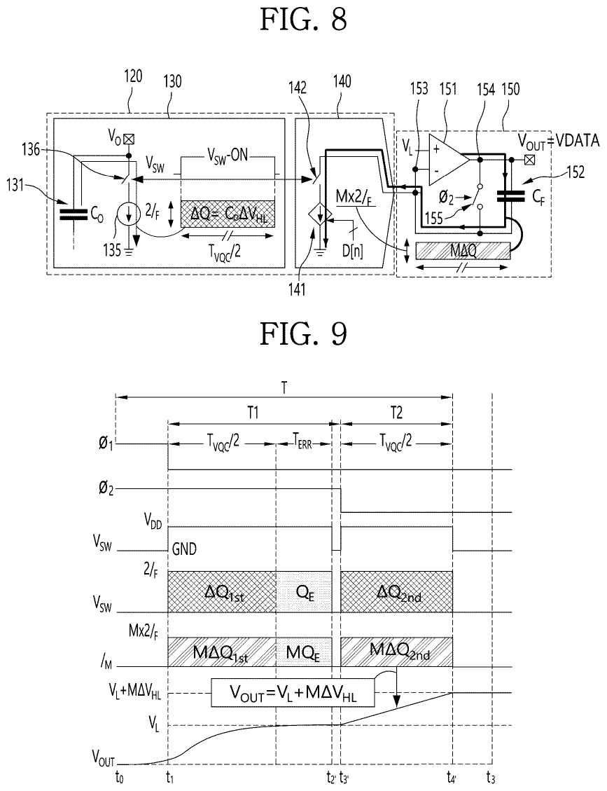

Meanwhile, FIG. 8 is a drawing explaining the operation of the second digital-to-analog converter and the third digital-to-analog converter of FIG. 5. FIG. 9 is an operational waveform diagram of the second digital-to-analog converter and the third digital-to-analog converter of FIG. 5.

As illustrated in FIGS. 8 and 9, in the present disclosure, the current of the first current source 135 may be 2IF, which is twice as large as the current IF of one aspect of the present disclosure (FIGS. 1 to 4). Furthermore, in the present disclosure, even if two voltage-to-charge conversion processes are performed, one horizontal period T corresponding to t0 to t4′ may be shorter than one horizontal period T corresponding to t0 to t3 in one aspect of the present disclosure (FIGS. 1 to 4), enabling high-speed operation.

A first charge signal CS1 (Equation 1) of ΔQ may be obtained through two voltage-to-charge conversion processes in the voltage-to-charge converter 130 of the second digital-to-analog converter 120, and a modulation factor M may be obtained in the charge modulator 140 of the second digital-to-analog converter 120, thereby obtaining a second charge signal CS2 (Equation 2) of MAQ.

An offset voltage of MΔV_{HL} may be obtained using the second capacitor 152 in the third digital-to-analog converter 150. The offset voltage may vary depending on the modulation factor M. For example, when the lower bits D[n] is 4 bits, 16 different offset voltages may be obtained depending on the modulation factor M.

As illustrated in FIG. 9, the third digital-to-analog converter 150 may turn on the fifth control switch 155 during a first time period T1 and supply the output voltage Vₒᵤₜ, which follows the first voltage V_{L} input to the buffer 151, as the data voltage VDATA to the data line of the display panel.

The third digital-to-analog converter 150 may turn off the fifth control switch 155 during a second time period T2, inject the second charge signal CS2 obtained from the second digital-to-analog converter 120 into the second capacitor 152 to obtain an offset voltage, and supply the output voltage Vₒᵤₜ, which is obtained by adding the obtained offset voltage to the first voltage V_{L}, to the data line.

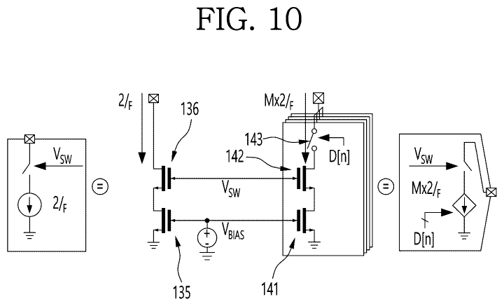

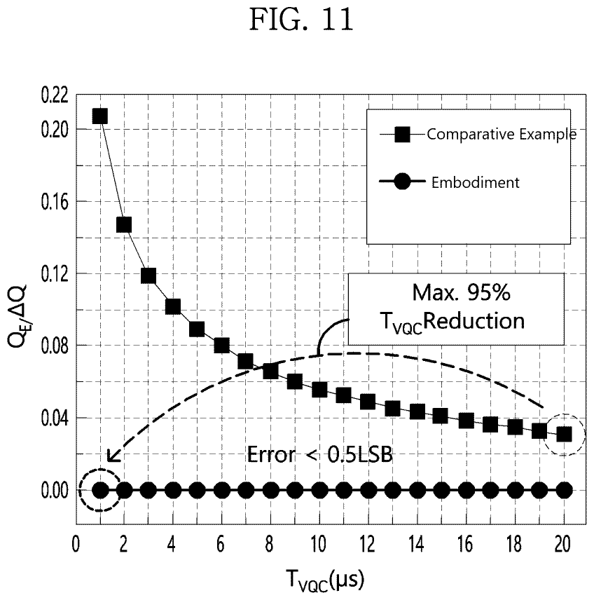

FIG. 10 is an equivalent circuit diagram of the voltage-to-charge converter and charge modulator of FIG. 5, respectively.

As illustrated in FIG. 10, the first current source 135 and each of the second current sources 141 may form a current mirror circuit.

The first current source 135, the second control switch 136, each of the plurality of second current sources 141, and each of the plurality of third control switches 142 may be NMOS transistors, but is not limited.

The second control switch 136 and the plurality of third control switches 142 may be turned on/off according to a second control signal V_{SW}.

The first current source 135 may be designed to allow a current of 2IF to flow. In this instance, when the second control switch 136 and the plurality of third control switches 142 are turned on by the second control signal V_{SW} of a high level, the current of 2IF flowing in the first current source 135 may be copied to the plurality of second current sources 141, thereby generating a current of 2IF in the second current source 141.

Meanwhile, a plurality of fourth control switches 143 may be provided to obtain a modulation factor M. The plurality of fourth control switches 143 may be selectively turned on/off according to the lower bits D[n] of the digital data signal.

An output current I_{M} having M×2IF may be obtained by the charge modulator 140. At this time, the modulation factor M may be expressed by the following equation 6.

$$M = {\sum }_{i = 0}^{3} \frac{1}{{2}^{4 - i}} \qquad [ Equation 6 ]$$

When the lower bits D[n] of the digital data signal is 4 bits, the selection of a second current source 141 among a plurality of second current sources 141 may be determined based on the bit values forming the 4-bit lower bits D[n], and an output current I_{M} may be obtained based on the currents generated by the selected second current sources 141.

The modulation factor M may be linearly adjusted from 0/16 to 15/16.

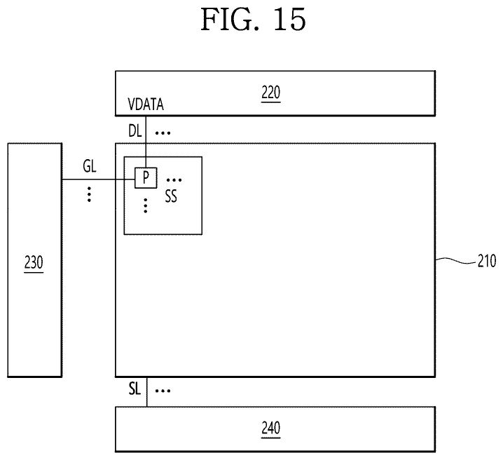

Meanwhile, FIG. 15 is a configuration diagram of a display device according to an aspect of the present disclosure.

Referring to FIG. 15, the display device according to an aspect of the present disclosure may comprise a display panel 210, a data driving device 220, a gate driving device 230, and a sensing driving device 240.

In one aspect of the present disclosure, the display panel 210 may comprise, but is not limited to, a liquid crystal display panel, an organic light-emitting display panel, etc.

The display panel 210 may comprise a plurality of gate lines GL, a plurality of data lines DL, and a plurality of pixels P. The plurality of gate lines GL may be electrically connected to a gate driving device 230. The plurality of data lines DL may be electrically connected to a data driving device 220. The plurality of pixels P may be electrically connected to the plurality of gate lines GL and the plurality of data lines DL.

One pixel P may have a size corresponding to at least one sensing cell SS, but is not limited thereto.

The sensing cell SS may comprise a sensing electrode. The sensing electrode may comprise, but is not limited to, a first sensing electrode (not shown) and a second sensing electrode (not shown). A predetermined capacitance may be formed between the first sensing electrode and the second sensing electrode. A driving signal may be provided to the first sensing electrode, and a sensing signal may be output from the second sensing electrode. When an object touches or approaches the sensing cell SS, the capacitance between the first and second sensing electrodes changes, and the changed capacitance may be output as a sensing signal. The object may comprise a hand, a finger, a pen, etc. Object sensing may also be performed using only a single sensing electrode, without distinction between the first and second sensing electrodes.

Meanwhile, the data driving device 220 may convert a digital data signal for displaying an image into an analog signal and supply it to the data line DL of the display panel 210.

According to one aspect of the present disclosure, a conversion device according to the first aspect (FIG. 1) and the second aspect (FIG. 5) of the present disclosure may be included in the data driving device 220. That is, the data driving device 220 comprises a plurality of conversion devices, and a plurality of output terminals 154 of the plurality of conversion devices may be electrically connected to a plurality of data lines DL of the display panel 210, respectively. In this instance, a plurality of analog signals converted by each of the plurality of conversion devices may be supplied as a plurality of data voltages VDATA to a plurality of data lines.

The gate driving device 230 may sequentially provide a scan signal to a plurality of gate lines GL to turn on or off a transistor located in each pixel P.

Depending on the driving method, the gate driving device 230 may be located only on one side of the display panel 210, as illustrated in this drawing, or may be divided into two and located on both sides of the display panel 210.

The sensing driving device 240 supplies a driving signal to all or part of a plurality of sensing cells SS electrically connected to a plurality of sensing lines SL.

As an example, the sensing driving device 240 may be configured separately from the data driving device 220 and the gate driving device 230. For example, the data driving device 220, the gate driving device 230, and the sensing driving device 240 may each be configured as individually integrated circuits. As another example, depending on the implementation method, the sensing driving device 240 may be included in the data driving device 220 or the gate driving device 230. As another example, the data driving device 220, the gate driving device 230, and the sensing driving device 240 may be configured as a single integrated circuit.

The sensing driving device 240 is not limited by its implementation and design method, and as long as its performance functions are identical or similar in one aspect of the present disclosure, it may be another component itself or may be provided internally or externally to another component.

The above detailed description should not be construed as limiting in all respects and should be considered illustrative. The scope of the aspects should be determined by reasonable interpretation of the appended claims, and all changes within the equivalent range of the aspects are included in the scope of the aspects.

What is claimed is:

1. A conversion device, comprising:
a first digital-to-analog converter configured to output two adjacent reference voltages among a plurality of reference voltages as a first voltage and a second voltage;
a second digital-to-analog converter electrically connected to the first digital-to-analog converter and configured to obtain a charge signal based on the first voltage and the second voltage; and
a third digital-to-analog converter electrically connected between the first digital-to-analog converter and a data line of a display panel, configured to supply the first voltage as a data voltage to the data line and supply the data voltage, which is obtained by adding an offset voltage to the first voltage, to the data line,
wherein the offset voltage is obtained using the obtained charge signal.

2. The conversion device of claim 1, wherein the second digital-to-analog converter comprises:
a voltage-to-charge converter configured to output a first charge signal proportional to a difference between the second voltage and the first voltage using a first capacitor electrically connected between a first node and a second node; and
a charge modulator configured to modulate the output first charge signal into a second charge signal using a modulation factor.

3. The conversion device of claim 2, wherein the first charge signal is determined by the difference between the second voltage and the first voltage.

4. The conversion device of claim 2, wherein the voltage-to-charge converter comprises:
a comparator configured to compare the first voltage with the second voltage to output a second control signal;
a first current source electrically connected to the first node; and
a second control switch electrically connected between the first node and the first current source and configured to connect the first current source and the first capacitor in response to the second control signal to obtain the first charge signal.

5. The conversion device of claim 2, wherein the voltage-to-charge converter further comprises:
a first control switch electrically connected to the first node and configured to control a supply of the second voltage for charging the first capacitor; and
a first multiplexer configured to selectively output the first voltage and the second voltage.

6. The conversion device of claim 5, wherein the first control switch and the first multiplexer are simultaneously operated in response to a first control signal.

7. The conversion device of claim 2, wherein the second charge signal is obtained by multiplying the first charge signal by the modulation factor.

8. The conversion device of claim 2, wherein the charge modulator comprises:
a plurality of second current sources electrically connected in parallel;
a plurality of third control switches electrically connected to the plurality of second current sources and configured to connect the plurality of second current sources to a second capacitor of the third digital-to-analog converter in response to the second control signal; and
a plurality of fourth control switches electrically connected between the second capacitor and the plurality of third control switches and configured to be selectively turned on/off in response to lower bits of a digital data signal.

9. The conversion device of claim 8, wherein the modulation factor is obtained by selectively turning on/off the plurality of fourth control switches in response to the lower bits.

10. The conversion device of claim 2, wherein the third digital-to-analog converter comprises:
a buffer; and
a second capacitor feedback-connected between an output terminal and an input terminal of the buffer.

11. The conversion device of claim 10, wherein the voltage-to-charge converter further comprises a second multiplexer electrically connected to the second node and configured to cancel an error charge signal.

12. The conversion device of claim 11, wherein the second multiplexer is configured to:
supply the first voltage through the second node during a first time period, and
supply the second voltage through the second node during a second time period to the first node to generate a difference value between the second voltage and the error voltage.

13. The conversion device of claim 12, wherein the third digital-to-analog converter further comprises a fifth control switch electrically connected in parallel with the second capacitor between the output terminal and the input terminal, and configured to be selectively turned on/off depending on the first time period and the second time period.

14. The conversion device of claim 13, wherein the third digital-to-analog converter is configured to:
turn on the fifth control switch during the first time period to supply the first voltage to the data line as the data voltage,
turn off the fifth control switch during the second time period to inject the modulated second charge signal into the second capacitor to obtain the offset voltage, and
supply to the data line the data voltage obtained by adding the obtained offset voltage to the first voltage.

15. A conversion method, comprising:
outputting, by a first digital-to-analog converter, two adjacent reference voltages among a plurality of reference voltages as a first voltage and a second voltage;
obtaining, by a second digital-to-analog converter electrically connected to the first digital-to-analog converter, a charge signal based on the first voltage and the second voltage; and
supplying, by a third digital-to-analog converter electrically connected between the first digital-to-analog converter and a data line of a display panel, the first voltage to the data line as a data voltage, and supplying the data voltage, which is obtained by adding an offset voltage to the first voltage, to the data line,
wherein the offset voltage is obtained using the obtained charge signal.

16. The conversion method of claim 15, wherein the obtaining of the charge signal based on the first voltage and the second voltage comprises:
outputting a first charge signal proportional to a difference between the second voltage and the first voltage using a first capacitor electrically connected between a first node and a second node; and
modulating the outputted first charge signal into a second charge signal using a modulation factor.

17. The conversion method of claim 16, wherein the outputting of the first charge signal comprises:
comparing the first voltage with the second voltage to output a second control signal; and
connecting the first current source electrically connected to the first node and the first capacitor according to the second control signal to obtain the first charge signal.

18. A data driving device, comprising:
a plurality of conversion devices configured to supply a plurality of data voltages to a plurality of data lines of a display panel,
wherein each of the plurality of conversion devices comprise:
a first digital-to-analog converter configured to output two adjacent reference voltages among a plurality of reference voltages as a first voltage and a second voltage;
a second digital-to-analog converter electrically connected to the first digital-to-analog converter and configured to obtain a charge signal based on the first voltage and the second voltage; and
a third digital-to-analog converter electrically connected between the first digital-to-analog converter and the data line of the display panel and configured to supply the first voltage as a data voltage to the data line and supply the data voltage, which is obtained by adding an offset voltage to the first voltage, to the data line, and
the offset voltage is obtained using the obtained charge signal.

19. The data drive device of claim 18, wherein the second digital-to-analog converter comprises:
a voltage-to-charge converter configured to output a first charge signal proportional to a difference between the second voltage and the first voltage using a first capacitor electrically connected between a first node and a second node; and
a charge modulator configured to modulate the output first charge signal into a second charge signal using a modulation factor.

20. The data drive device of claim 19, wherein the voltage-to-charge converter comprises:
a comparator configured to compare the first voltage with the second voltage to output a second control signal;
a first current source electrically connected to the first node; and
a second control switch electrically connected between the first node and the first current source and configured to connect the first current source and the first capacitor in response to the second control signal to obtain the first charge signal.
